(19) United States
(12) Patent Application Publication
(10) Pub. No.: US 2026/0227263 A1
(43) Pub. Date: Aug. 6, 2026

(54) BALANCE CORRECTION INFORMATION OF A ROTATING BODY

(71) Applicant: IHI Corporation, Tokyo (JP)

(72) Inventors: Koshi ISHIMOTO, Tokyo (JP); Toyoki TAKAZAKURA, Tokyo (JP)

(21) Appl. No.: 19/578,906

(22) Filed: Mar. 26, 2026

Related U.S. Application Data
(63) Continuation-in-part of application No. PCT/JP2024/018167, filed on May 16, 2024.

(30) Foreign Application Priority Data
Sep. 28, 2023 (JP) 2023-167667

(51) Int. Cl. G01M 1/22

(52) U.S. Cl. CPC G01M 1/22

(57) ABSTRACT

A method of obtaining balance correction information of a rotating body includes obtaining first vibration data when the rotating body is rotating at a specific rotational speed without trial cutting being performed on the rotating body and obtaining second vibration data when the rotating body is rotating at a low-range rotational speed lower than the specific rotational speed without the trial cutting being performed on the rotating body. The method additionally includes obtaining third vibration data when the rotating body on which the trial cutting has been performed at the first correction position is rotating at the specific rotational speed and obtaining the balance correction information based on the first vibration data, the second vibration data, and the third vibration data.

### CROSS-REFERENCE TO RELATED APPLICATIONS

This application is a continuation-in-part application of PCT Application No. PCT/JP 2024/018167, filed on May 16, 2024, which claims the benefit of priority from Japanese Patent Application No. 2023-167667, filed on Sep. 28, 2023. The entire contents of the above listed PCT and priority applications are incorporated herein by reference.

### BACKGROUND

The present disclosure relates to a method of obtaining balance correction information and an apparatus for obtaining balance correction information.

When vibration of a rotating body rotating at a high speed is measured using a vibrometer, vibration data is obtained. Non-uniformity of mass distribution around the axis of rotation of the rotating body is a cause of dynamic unbalance. The above-mentioned vibration data includes a vibration component caused by dynamic unbalance. Furthermore, the vibration data may include other vibration components due to factors different from the vibration component caused by dynamic unbalance. For example, as one of the other vibration components due to the factors different from the vibration component caused by dynamic unbalance, there is a component that makes it appear as if the rotating body is vibrating, due to the outer shape of the rotating body. Such a phenomenon is referred to as runout.

For example, Japanese Unexamined Patent Application Publication No. H7-270229 discloses a rotating machine testing apparatus. The testing apparatus determines the amount of shape irregularity when the rotating body is stationary as a runout amount. Then, the amount of shape irregularity at the rotational speed during operation is determined from the runout amount. By subtracting the amount of shape irregularity during operation from the vibration that occurs during operation and is synchronized with the rotation, highly accurate vibration characteristics can be obtained.

### SUMMARY

An example method of obtaining balance correction information of a rotating body may include: obtaining first vibration data along a direction intersecting an axis of rotation of the rotating body, when the rotating body is rotating at a specific rotational speed without a trial weight being applied to the rotating body and without trial cutting being performed on the rotating body; obtaining second vibration data along a direction intersecting the axis of rotation, when the rotating body is rotating at a low-range rotational speed lower than the specific rotational speed without the trial weight being applied to the rotating body and without the trial cutting being performed on the rotating body; obtaining third vibration data along a direction intersecting the axis of rotation, when the rotating body to which the trial weight has been applied at a first correction position is rotating at the specific rotational speed, or when the rotating body on which the trial cutting has been performed at the first correction position is rotating at the specific rotational speed; and obtaining the balance correction information based on the first vibration data, the second vibration data, and the third vibration data.

### BRIEF DESCRIPTION OF THE DRAWINGS

FIG. 1 is a diagram schematically illustrating a state in which balance correction is performed by applying an example method of obtaining balance correction information and an apparatus for obtaining balance correction information.

FIG. 2 is a diagram illustrating example steps of the method of obtaining balance correction information.

FIG. 3 is a diagram illustrating a functional configuration of an example apparatus for obtaining balance correction information.

FIG. 4 is a diagram illustrating an example method of obtaining runout information.

### DETAILED DESCRIPTION

One aspect of the present disclosure is a method of obtaining balance correction information for correcting a dynamic unbalance of a rotating body rotatably supported by a non-contact type bearing and rotating about an axis of rotation. The method of obtaining balance correction information comprises: obtaining first vibration data along a direction intersecting the axis of rotation, when the rotating body is rotating at a specific rotational speed without a trial weight being applied to the rotating body and without trial cutting being performed on the rotating body; obtaining second vibration data along a direction intersecting the axis of rotation, when the rotating body is rotating at a low-range rotational speed lower than the specific rotational speed without the trial weight being applied to the rotating body and without the trial cutting being performed on the rotating body; obtaining third vibration data along a direction intersecting the axis of rotation, when the rotating body to which the trial weight has been applied at a first correction position is rotating at the specific rotational speed, or when the rotating body on which the trial cutting has been performed at the first correction position is rotating at the specific rotational speed; obtaining a first influence coefficient indicating a degree of an effect that the application of the trial weight or the performance of the trial cutting has on vibration of the rotating body, using the first vibration data and the third vibration data; obtaining runout information indicating a degree of runout caused by a shape of the rotating body, using the second vibration data; and obtaining the balance correction information using the first vibration data, the first influence coefficient, and the runout information.

Another aspect of the present disclosure is an apparatus for obtaining balance correction information for correcting a dynamic unbalance of a rotating body rotatably supported by a non-contact type bearing and rotating about an axis of rotation. The apparatus for obtaining balance correction information comprises: a vibration data obtaining unit configured to receive: first vibration data along a direction intersecting the axis of rotation, when the rotating body is rotating at a specific rotational speed without a trial weight being applied to the rotating body and without trial cutting being performed on the rotating body; second vibration data along a direction intersecting the axis of rotation, when the rotating body is rotating at a low-range rotational speed lower than the specific rotational speed without the trial weight being applied to the rotating body and without the trial cutting being performed on the rotating body; and third vibration data along a direction intersecting the axis of rotation, when the rotating body to which the trial weight has been applied at a first correction position is rotating at the specific rotational speed, or when the rotating body on which the trial cutting has been performed at the first correction position is rotating at the specific rotational speed; an influence coefficient obtaining unit configured to obtain an influence coefficient indicating a degree of an effect that the application of the trial weight or the performance of the trial cutting has on vibration of the rotating body, using the first vibration data and the third vibration data; a runout information obtaining unit configured to obtain runout information indicating a degree of runout caused by a shape of the rotating body, using the second vibration data; and a balance correction information obtaining unit configured to obtain the balance correction information using the vibration data, the first influence coefficient, and the runout information.

According to the method of obtaining balance correction information and the apparatus for obtaining balance correction information, runout information is obtained using the second vibration data along a direction intersecting the axis of rotation when the rotating body is rotating at a low-range rotational speed lower than the specific rotational speed without a trial weight being applied to the rotating body and without trial cutting being performed on the rotating body. By doing so, balance correction information can be obtained even with one less unknown variable than in the related art. As a result, the balance correction information can be obtained with a smaller number of measurement data. Therefore, highly accurate balance correction information that takes runout into account can be readily obtained with a smaller number of measurement data.

In the step of obtaining the first vibration data of the method of obtaining balance correction information of one aspect, the first vibration data may be acquired by applying a predetermined driving force to the rotating body to bring the rotating body into a forced rotation state of rotating at the specific rotational speed. The step of obtaining the second vibration data may be performed after the step of obtaining the first vibration data, and the second vibration data may be acquired by stopping application of the predetermined driving force that was applied in the step of obtaining the first vibration data to bring the rotating body into a free rotation state in which the rotational speed of the rotating body gradually decreases. By these steps, accurate runout information can be obtained.

The method of obtaining balance correction information of one aspect may further comprise: obtaining fourth vibration data along a direction intersecting the axis of rotation, when the rotating body to which the trial weight has been applied at a second correction position different from the first correction position is rotating at the specific rotational speed, or when the rotating body on which the trial cutting has been performed at the second correction position is rotating at the specific rotational speed; and obtaining a second influence coefficient indicating a degree of an effect that the application of the trial weight or the performance of the trial cutting has on vibration of the rotating body, using the third vibration data and the fourth vibration data. By these steps, so-called two-plane balancing can be performed as the correction of the rotational balance.

In the method of obtaining balance correction information of one aspect, the specific rotational speed may be higher than a levitation rotational speed at which the rotating body levitates from the bearing. The low-range rotational speed may be lower than the levitation rotational speed. Accurate runout information can also be obtained under these conditions.

In the method of obtaining balance correction information of one aspect, the specific rotational speed may be higher than a primary critical rotational speed of the rotating body. The low-range rotational speed may be lower than the primary critical rotational speed of the rotating body. Accurate runout information can also be obtained under these conditions.

In the following description, with reference to the drawings, the same reference numbers are assigned to the same components or to similar components having the same function, and overlapping description is omitted.

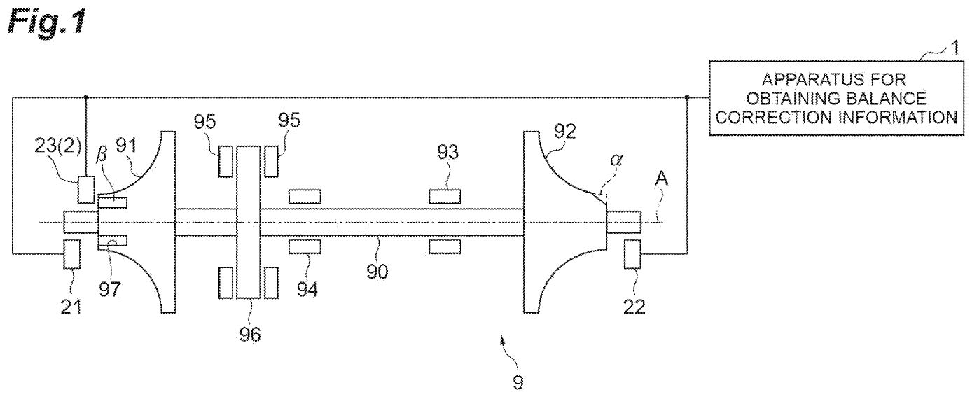

As shown in FIG. 1, the method of obtaining balance correction information and the apparatus for obtaining balance correction information 1 are used to correct the balance of a rotating body 9 that rotates about an axis of rotation A. The rotating body 9 has a shaft 90 and two impellers 91 and 92. The rotating body 9 is, for example, a component of a supercharger. The rotating body 9 is rotatably supported by two journal bearings 93 and 94 and a pair of thrust bearings 95.

The journal bearings 93 and 94 are non-contact type bearings. For example, the journal bearings 93 and 94 are a type of gas bearing. The journal bearings 93 and 94 levitate during rotation by drawing fluid between the shaft 90 and the inner peripheral surfaces of the bearings. When the rotational speed is higher than a predetermined levitation rotational speed, the rotating body 9 does not physically contact the journal bearings 93 and 94.

Similarly, the thrust bearings 95 are a non-contact type bearing. For example, the thrust bearings 95 may be foil bearings using corrugated bump foils. When the shaft 90 rotates at a rotational speed higher than a predetermined rotational speed, fluid films are formed between a thrust collar 96 and the thrust bearings 95. Therefore, when the shaft 90 rotates at a rotational speed higher than the predetermined rotational speed, the rotating body 9 does not physically contact the thrust bearings 95.

When there is an imbalance in the mass distribution around the axis of rotation A, a centrifugal force corresponding to the unbalanced mass periodically acts on the rotating body 9. That is, the rotating body 9 may vibrate at a frequency corresponding to the rotational speed.

When the rotating body 9 is rotated about the axis of rotation A, due to non-uniformity of the outer shape with respect to the axis of rotation A, periodic fluctuations in displacement having a frequency corresponding to the rotational speed are detected by the displacement sensors 21 and 22. Therefore, the rotating body 9 appears to be vibrating. This apparent vibration is called runout.

When the rotating body 9 is rotated, the information on the periodic displacement detected by the displacement sensors 21 and 22 includes a component caused by dynamic unbalance and a component caused by runout. The balance correction of the rotating body 9 aims to reduce the component caused by dynamic unbalance. Therefore, if the output of the displacement sensors 21 and 22 includes a component caused by runout, the accuracy of the balance correction tends to decrease. The method of obtaining balance correction information and the apparatus for obtaining balance correction information 1 suppress the influence of runout and obtain accurate balance correction information.

When the rotating body 9 is rotated at a low speed, the centrifugal force decreases. Therefore, the magnitude of the component caused by dynamic unbalance is reduced. On the other hand, since the component caused by runout is due to the shape of the rotating body 9, its magnitude is not affected by the rotational speed. Therefore, it is conceivable to rotate the rotating body 9 at a low speed in order to estimate the component caused by runout.

However, as described above, the rotating body 9 is supported by the non-contact type journal bearings 93 and 94. In order for the journal bearings 93 and 94 to be in a non-contact rotational support state, the rotational speed of the rotating body 9 is higher than a predetermined levitation rotational speed. That is, it is difficult to estimate the component caused by runout by rotating the rotating body 9 at a low speed.

Assume that the rotating body 9 is supported by a contact-type bearing such as a rolling bearing. In this case, the vibration of the rotating body 9 is transmitted to the bearing, and further transmitted to the housing to which the bearing is mounted Therefore, the vibration of the rotating body 9 supported by a contact-type bearing such as a rolling bearing can be indirectly detected by a sensor attached to the housing.

However, as previously discussed, the rotating body 9 is supported by the non-contact type journal bearings 93 and 94. The vibration of the rotating body 9 is not readily transmitted to the housing or the like via the journal bearings 93 and 94 or the thrust bearings 95. Therefore, for the vibration of the rotating body 9, highly accurate measurement can be achieved by using the non-contact type displacement sensors 21 and 22 and the rotation pulse sensor 23.

The method of obtaining balance correction information and the apparatus for obtaining balance correction information 1 are applicable to balance correction under such special conditions, and are capable of obtaining accurate balance correction results with a simple method. Hereinafter, the method of obtaining balance correction information and the apparatus for obtaining balance correction information 1 will be described in detail.

### Method of Correcting Balance

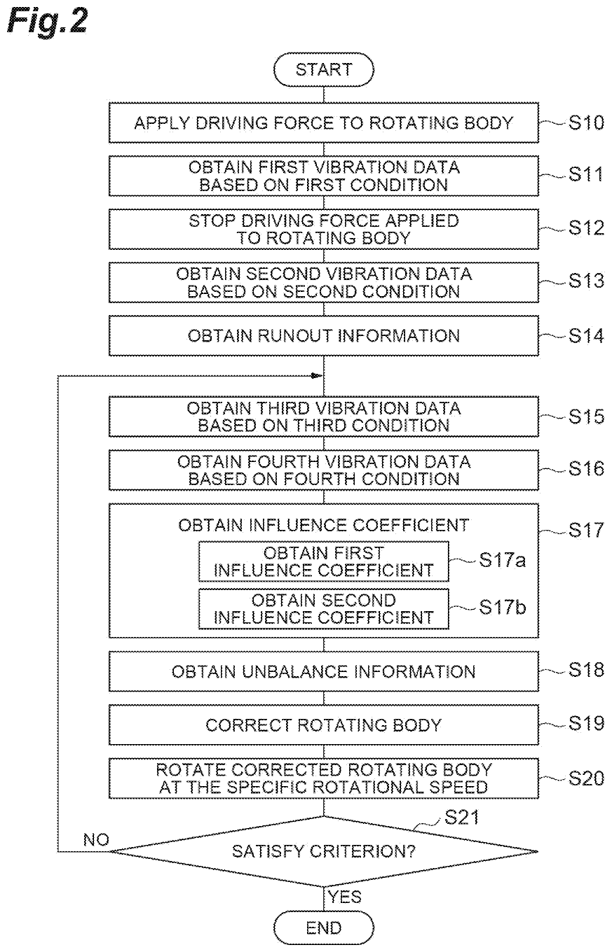

A method of correcting balance will be described with reference to FIG. 2. The method of obtaining balance correction information is for the method of correcting balance. Balance correction information is used to correct the balance of the rotating body 9. The method of obtaining balance correction information obtains balance correction information for correcting the balance. The method of correcting the balance mainly includes an operation of measuring the rotating body 9, an operation of obtaining balance correction information using data obtained by the measurement, and an operation of correcting the rotating body 9 according to the balance correction information.

By applying a driving force to the rotating body 9, the rotating body 9 is brought into a state of rotating at a specific rotational speed (S10). In step S10, no trial cutting α (refer to FIG. 1) is performed on the rotating body 9. In step S10, no trial weight β (refer to FIG. 1) is applied either. In the state of step S10, a driving force is applied, and the specific rotational speed is maintained even as time passes. The state of step S10 may be referred to as a forced rotation state. Therefore, a first condition is defined by the elements that “no trial cutting α is performed and no trial weight β is applied,” “a driving force is applied,” and “the rotational speed is the specific rotational speed.” The specific rotational speed may be, for example, a rotational speed during steady-state operation set for the rotating body 9. At the specific rotational speed, the rotating body 9 is supported in a non-contact manner by the journal bearings 93 and 94 and the thrust bearings 95. That is, the rotating body 9 is levitating. Therefore, the specific rotational speed is higher than the levitation rotational speed.

The “trial cutting α” performed on the rotating body 9 may include partially removing the impellers 91 and/or 92 by cutting or the like. The “trial cutting α” may include removing a portion of an outer end surface of the impellers 91 and/or 92 in a circumferential direction, as illustrated in FIG. 1. The “application of the trial weight β” to the rotating body 9 may include attaching at least one trial weight β to the impellers 91 and/or 92. The “application of the trial weight β” may include disposing the at least one trial weight β in at least one hole 97 provided in the outer end surface of the impellers 91 and/or 92, as illustrated in FIG. 1. The at least one hole 97 may be a female screw having a thread groove formed on an inner peripheral surface thereof, and the at least one trial weight β may be a male screw having a screw thread formed on an outer peripheral surface thereof. In this case, the at least one trial weight β may be attached to the at least one hole 97 by screwing the male screw of the at least one trial weight β into the female screw of the at least one hole 97.

Next, first vibration data V1 based on the first condition is obtained (S11). This step S11 is executed by the displacement sensors 21 and 22, the rotation pulse sensor 23, and the apparatus for obtaining balance correction information 1. In the step S11 of obtaining the first vibration data, the driving force may not be constantly applied. However, in other examples, the driving force may be applied to maintain the specific rotational speed. Therefore, as long as the specific rotational speed is maintained over time, it can be considered that the driving force is being applied. For example, during the period of obtaining the first vibration data, a period of applying the driving force and a period of stopping the driving force may be alternately repeated.

Next, the driving force applied to the rotating body 9 is stopped (S12).

Next, second vibration data V2 based on a second condition is obtained (S13). This step S13 is also executed by the displacement sensors 21 and 22, the rotation pulse sensor 23, and the apparatus for obtaining balance correction information 1. Unlike the step S11, during the period of obtaining the second vibration data, a driving force is not applied. As a result, the rotational speed gradually decreases over time. That is, the state of step S13 may be referred to as a free rotation state. Therefore, the second condition is defined by the elements that “no trial cutting α is performed and no trial weight β is applied,” “no driving force is applied,” and “the rotational speed gradually decreases.” After obtaining the second vibration data V2, the rotation of the rotating body 9 is completely stopped.

The rotational speed when obtaining the second vibration data V2 is lower than the specific rotational speed. In the following description, the rotational speed when obtaining the second vibration data V2 is referred to as a “low-range rotational speed” for convenience. For example, the low-range rotational speed may be a value predetermined by a preliminary test in advance. The low-range rotational speed may be a value lower than the primary critical rotational speed of the rotating body 9. If the levitation rotational speed of the journal bearings 93 and 94 is known, a value in the vicinity of the levitation rotational speed may be set as the low-range rotational speed. That is, a value slightly higher than the levitation rotational speed may be set as the low-range rotational speed. A value equal to the levitation rotational speed may be set as the low-range rotational speed. A value slightly lower than the levitation rotational speed may be set as the low-range rotational speed.

From another perspective, the low-range rotational speed may be set low. In some examples, the rotational speed in the low-speed range is variable, or non-uniform. In other examples, the rotation speed is constant to avoid sudden changes in the rotational speed. The low-range rotational speed may be the lowest rotational speed at which the rotating body 9 can rotate smoothly.

Next, runout information is obtained (S14). This step S14 is executed by the apparatus for obtaining balance correction information 1. A specific process for obtaining runout information executed by the apparatus for obtaining balance correction information 1 will be described later.

Next, third vibration data V3 based on a third condition is obtained (S15). This step S15 is also executed by the displacement sensors 21 and 22, the rotation pulse sensor 23, and the apparatus for obtaining balance correction information 1. Trial cutting α is performed on the rotating body 9. In the step S15, a portion corresponding to a first axial position of the rotating body 9 is cut. A driving force is applied to the rotating body 9 on which the trial cutting α has been performed, and the rotating body 9 on which the trial cutting has α been performed is rotated at the specific rotational speed. The state of rotation in the step S15 is the same as that in the step S11, and the step S15 differs from the step S11 only in that trial cutting α is performed on the rotating body 9. Therefore, the third condition is defined by the elements that “a portion corresponding to the first axial position of the rotating body 9 is cut by performing trial cutting α,” “a driving force is applied,” and “the rotational speed is the specific rotational speed.” After obtaining the third vibration data V3, the rotation of the rotating body 9 is completely stopped.

Next, fourth vibration data V4 based on a fourth condition is obtained (S16). This step S16 is also executed by the displacement sensors 21 and 22, the rotation pulse sensor 23, and the apparatus for obtaining balance correction information 1. Trial cutting α is also performed in this step S16. The trial cutting α in the step S16 cuts a portion corresponding to a second axial position different from the first axial position. Then, a driving force is applied to the rotating body 9 on which the trial cutting α has been performed, and the rotating body 9 on which the trial cutting α has been performed is rotated at the specific rotational speed. The state of rotation in the step S16 is the same as that in the steps S11 and S15. The step S16 differs from the step S11 only in that portions corresponding to the first axial position and the second axial position are cut. The step S16 differs from the step S15 in the position that is cut by the trial cutting α. Therefore, the fourth condition is defined by the elements that “portions corresponding to the first axial position and the second axial position of the rotating body 9 are cut by performing trial cutting α” and “the rotational speed is the specific rotational speed.” After obtaining the fourth vibration data V4, the rotation of the rotating body 9 is completely stopped.

Next, an influence coefficient is obtained (S17). The step S17 is executed by the apparatus for obtaining balance correction information 1. A specific process for obtaining the influence coefficient executed by the apparatus for obtaining balance correction information 1 will be described later.

Next, unbalance information is obtained (S18). The step S18 is also executed by the apparatus for obtaining balance correction information 1. A specific process for obtaining the unbalance information executed by the apparatus for obtaining balance correction information 1 will be described later.

Next, the rotating body 9 is corrected (S19). The step S19 is performed by an operator. The operator corrects the rotating body 9 based on the unbalance information obtained from the apparatus for obtaining balance correction information 1. In some examples, using the unbalance information, a correction mass and a position (phase) at which to apply the correction mass are determined. The balance correction information includes the correction mass and the position at which to apply the correction mass. The method of obtaining balance correction information and the apparatus for obtaining balance correction information, as the balance correction information, the information itself including the correction mass and the position at which to apply the correction mass, or information that indirectly presents such information.

Next, the corrected rotating body 9 is rotated at the specific rotational speed (S20). In the step S20, vibration measurement is performed again on the corrected rotating body 9 under the first condition.

It is determined whether the result of the vibration data in the step S20 satisfies a criterion (S21). If the result of the vibration data in the step S20 satisfies the criterion (step S21: YES), the operation of correcting the balance of the rotating body 9 is completed. If the result of the vibration data in the step S20 does not satisfy the criterion (step S21: NO), the process may be performed again from the step S15.

### Apparatus for Obtaining Balance Correction Information

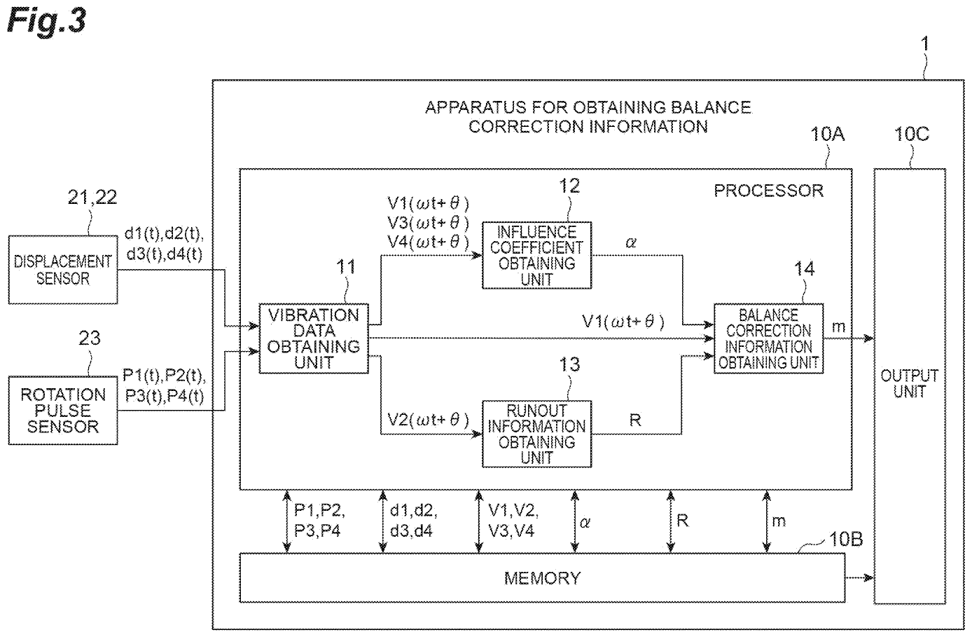

The apparatus for obtaining balance correction information 1 will be described. As shown in FIG. 3, the apparatus for obtaining balance correction information 1 is physically a computer. A processor 10A included in the computer executes a program that defines a series of processes for obtaining balance correction information m using displacement data d and rotation pulse data P. As a result, several functional components constituting the apparatus for obtaining balance correction information 1 are implemented.

As shown in FIG. 3, the apparatus for obtaining balance correction information 1 receives displacement data d from the displacement sensors 21 and 22. The apparatus for obtaining balance correction information 1 receives rotation pulse data P from the rotation pulse sensor 23. The apparatus for obtaining balance correction information 1 obtains balance correction information m using the displacement data d and the rotation pulse data P. The apparatus for obtaining balance correction information 1 presents the balance correction information m to an operator.

The apparatus for obtaining balance correction information 1 has, as functional components, a vibration data obtaining unit 11, an influence coefficient obtaining unit 12, a runout information obtaining unit 13, and a balance correction information obtaining unit 14. These functional components are implemented by the processor 10A executing a predetermined program. In addition to the processor 10A, the apparatus for obtaining balance correction information 1 has a memory 10B that stores various data used for the processing of these functional components. The memory 10B receives data from the functional components. Furthermore, the memory 10B passes the stored data to the requesting functional component in response to a request from the functional component. The functional components may exchange data with each other. The functional components may indirectly exchange data via the memory 10B without directly exchanging data with each other.

The vibration data obtaining unit 11 receives the displacement data d and the rotation pulse data P. The vibration data obtaining unit 11 may receive the displacement data d directly from the displacement sensors 21 and 22. The vibration data obtaining unit 11 may receive the displacement data d stored in the memory 10B from the memory 10B. The vibration data obtaining unit 11 may receive the rotation pulse data P directly from the rotation pulse sensor 23. The vibration data obtaining unit 11 may receive the rotation pulse data P stored in the memory 10B from the memory 10B. The vibration data obtaining unit 11 obtains vibration data V using the displacement data d and the rotation pulse data P. The vibration data obtaining unit 11 outputs the vibration data V to the influence coefficient obtaining unit 12, the runout information obtaining unit 13, and the balance correction information obtaining unit 14. The vibration data obtaining unit 11 may output the vibration data V to the memory 10B. The vibration data obtaining unit 11 executes the steps S11, S13, S15, and S16 shown in the flowchart of FIG. 2.

The vibration data obtaining unit 11 obtains first vibration data V1 using first displacement data d1 and first rotation pulse data P1 obtained under the first condition. Similarly, it obtains second, third, and fourth vibration data V2 to V4 using second, third, and fourth displacement data d2 to d4 and second, third, and fourth rotation pulse data P2 to P4, which are obtained under the second, third, and fourth conditions. The displacement data d is data in which time and displacement are associated with each other. The rotation pulse data P is data in which time and phase are associated with each other. The vibration data V is defined by the displacement (amplitude) indicated by the displacement data d and the phase indicated by the rotation pulse data P.

The influence coefficient obtaining unit 12 receives the vibration data V from the vibration data obtaining unit 11. The influence coefficient obtaining unit 12 may receive the vibration data V from the memory 10B. The influence coefficient obtaining unit 12 obtains an influence coefficient α using the vibration data V. The influence coefficient obtaining unit 12 outputs the influence coefficient α to the balance correction information obtaining unit 14. The influence coefficient obtaining unit 12 may output the influence coefficient α to the memory 10B. The influence coefficient obtaining unit 12 executes the step S17 shown in the flowchart of FIG. 2.

The influence coefficient obtaining unit 12 obtains a first influence coefficient α using the first vibration data V1 obtained from the rotating body 9 on which no trial cutting has been performed and to which no trial weight has been applied, and the third vibration data V3 obtained from the rotating body 9 on which a portion corresponding to the first axial position has been cut (step S17a). The influence coefficient obtaining unit 12 obtains a second influence coefficient α using the third vibration data V3 obtained from the rotating body 9 on which the portion corresponding to the first axial position has been cut, and the fourth vibration data V4 obtained from the rotating body 9 on which the portion corresponding to the second axial position has been further cut in addition to the first axial position (step S17b). For the process of obtaining the influence coefficient using the vibration data obtained from the rotating body 9 on which no trial cutting has been performed and to which no trial weight has been attached, and the vibration data obtained from the rotating body 9 on which trial cutting has been performed, a known method may be used.

The runout information obtaining unit 13 receives the second vibration data V2 from the vibration data obtaining unit 11. The runout information obtaining unit 13 may receive the second vibration data V2 from the memory 10B. The runout information obtaining unit 13 obtains runout information R using the second vibration data V2. The runout information obtaining unit 13 outputs the runout information R to the balance correction information obtaining unit 14. The runout information obtaining unit 13 may output the runout information R to the memory 10B. The runout information obtaining unit 13 executes the step S14 shown in the flowchart of FIG. 2.

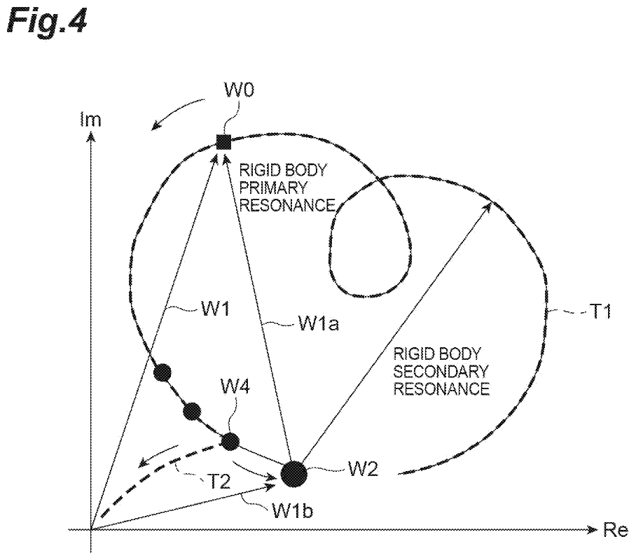

For example, the vibration data V itself at a low rotational speed may be regarded as the runout information. FIG. 4 is a diagram illustrating the state of vibration when the rotational speed gradually decreases from the specific rotational speed. The vibration data can be represented using imaginary numbers. In FIG. 4, the horizontal axis indicates real numbers. The vertical axis indicates imaginary numbers. The vibration when rotating at a certain rotational speed can be represented as a point on a first trajectory T1. A vector connecting a point on the first trajectory T1 and the origin is defined. The magnitude of the vector indicates the amplitude of the vibration. The angle of the vector indicates the phase of the vibration.

For example, suppose that the vibration when rotating at a certain rotational speed is indicated by a point W0. At this time, the vibration data V can be expressed by the magnitude of a vector W1 and the angle (phase) of the vector W1. The vibration data V represented by the vector W1 includes a component caused by dynamic unbalance and a component caused by runout. Referring to FIG. 4, it can be seen that the vector W1 indicating the vibration data V is the sum of the vector component W1a caused by dynamic unbalance and the vector component W1b caused by runout. The magnitude (amplitude of vibration) and phase of the vector component W1a caused by dynamic unbalance change according to the rotational speed. On the other hand, the magnitude and phase of the vector component W1b caused by runout are not affected by the rotational speed. The magnitude and phase of the vector component W1b caused by runout are constant.

As the rotational speed decreases, the first trajectory T1 converges toward a point W2. The point W2 indicates the true runout. However, the first trajectory T1 will not reach the point W2. This is because the rotating body 9 is supported by the non-contact type journal bearings 93 and 94, and in a region below the levitation rotational speed, the shaft 90 contacts the journal bearings 93 and 94. This contact causes the vibration state of the rotating body 9 to change. The manner in which the vibration state of the rotating body 9 changes is indicated by a second trajectory T2.

Therefore, a point W4 where the first trajectory T1 switches to the second trajectory T2 is defined as a discontinuous point. Then, the vibration data at a rotational speed in the vicinity of the discontinuous point is treated as the runout information R to efficiently obtain the correction of the dynamic balance.

For example, each time the second vibration data V2 is obtained, the rotational speed of the point to be selected as runout may be determined each time by drawing the diagram shown in FIG. 4. When performing balance correction for a plurality of rotating bodies 9, the rotational speed of the point to be selected for runout is determined by drawing the diagram shown in FIG. 4 for a certain rotating body 9. Then, another rotating body 9 may use the already determined rotational speed as the low-range rotational speed, and obtain the runout information R from the vibration data V corresponding to that rotational speed.

The balance correction information obtaining unit 14 receives the vibration data V from the vibration data obtaining unit 11, receives the influence coefficient α from the influence coefficient obtaining unit 12, and receives the runout information R from the runout information obtaining unit 13. The balance correction information obtaining unit 14 may receive the vibration data V, the influence coefficient α, and the runout information R from the memory 10B. The balance correction information obtaining unit 14 obtains balance correction information m using the vibration data V, the influence coefficient α, and the runout information R. The balance correction information obtaining unit 14 outputs the balance correction information m. For example, the balance correction information obtaining unit 14 may output the balance correction information m to the memory 10B. The balance correction information obtaining unit 14 may output the balance correction information m via an output unit 10C constituting the apparatus for obtaining balance correction information 1. An example of the output unit 10C is a display.

The vibration data V, the influence coefficient α, the runout information R, and the unbalance information are defined by the following equation (1). In equation (1), V, R, and m represent vectors. α represents a matrix.

$$V = α m + R \qquad ( 1 )$$

Equation (1) includes four elements. The vibration data V, the influence coefficient α, and the runout information R are known. The unbalance information is an unknown variable. Therefore, by substituting the vibration data V, the influence coefficient α, and the runout information R into equation (1), the unbalance information can be obtained. The balance correction information m can be obtained to reduce this unbalance information. For example, the balance correction information m may be obtained to make the unbalance information zero.

By the way, in some rotating machines including the rotating body 9, the rotating body 9 cannot be taken out without disassembling the machine. In this case, the balance correction of the rotating body 9 is performed with the rotating body 9 assembled to a stationary structure. At that time, the vibration data is generally obtained from a sensor provided on the stationary structure. However, especially when the rotating body 9 is supported by a non-contact type gas bearing, sufficient balance accuracy may not be achieved with the vibration data of the stationary structure part. Therefore, the vibration of the rotating body 9 is measured using a non-contact displacement sensor. The vibration data measured by the non-contact displacement sensor includes not only the vibration component of the rotating body but also the runout of the vibration measurement part. The runout of the vibration measurement part includes mechanical runout and electromagnetic runout. Therefore, when performing balance correction using the result of vibration measurement obtained by the non-contact displacement sensor, both the unbalance and the runout are identified. To identify the unbalance and the runout, vibration data at two or more rotational speeds is used.

A high-speed rotating machine in which the rotating body 9 is supported by a gas bearing cannot continue to operate in a low-speed rotation range because a gas film is not formed. Also, vibration data acquired when the rotating body 9 is not sufficiently levitated cannot be used for identifying the unbalance. The levitation rotational speed is often relatively high. Therefore, if one tries to identify the unbalance and the runout using vibration data obtained when the rotational speed is equal to or higher than the levitation rotational speed, sufficient accuracy may not be obtained in the identification of the runout.

The method of obtaining balance correction information and the apparatus for obtaining balance correction information 1 have been conceived in view of the above.

The method of obtaining balance correction information m comprises: the step S11 of obtaining first vibration data V1 along a direction intersecting the axis of rotation A, when the rotating body 9 is rotating at the specific rotational speed without the trial weight being applied to the rotating body 9 and without trial cutting being performed on the rotating body 9; the step S13 of obtaining second vibration data V2 along a direction intersecting the axis of rotation A, when the rotating body 9 is rotating at the low-range rotational speed lower than the specific rotational speed without the trial weight being applied to the rotating body 9 and without the trial cutting being performed on the rotating body 9; the step S15 of obtaining third vibration data V3 along a direction intersecting the axis of rotation A, when the rotating body 9 on which trial cutting has been performed at a first correction position is rotating at the specific rotational speed; the step S17a of obtaining the first influence coefficient α indicating a degree of an effect that the trial cutting at the first correction position has on vibration of the rotating body 9, using the first vibration data V1 and the third vibration data V3; the step S14 of obtaining runout information R indicating a degree of runout caused by a shape of the rotating body 9, using the second vibration data V2; and the step S18 of obtaining the balance correction information using the first vibration data V1, the influence coefficient α, and the runout information R.

The apparatus for obtaining balance correction information 1 comprises: the vibration data obtaining unit 11 configured to receive: the first vibration data V1 along a direction intersecting the axis of rotation A, when the rotating body 9 is rotating at the specific rotational speed without the trial weight being applied and without trial cutting being performed; the second vibration data V2 along a direction intersecting the axis of rotation A, when the rotating body 9 is rotating at the low-range rotational speed lower than the specific rotational speed without the trial weight being applied and without trial cutting being performed; and the third vibration data V3 along a direction intersecting the axis of rotation A, when the rotating body 9 on which trial cutting has been performed at a first correction position is rotating at the specific rotational speed; the influence coefficient obtaining unit 12 configured to obtain the first influence coefficient α indicating a degree of an effect that the trial cutting at the first correction position has on vibration of the rotating body 9, using the first vibration data V1 and the third vibration data V3; the runout information obtaining unit 13 configured to obtain the runout information R indicating a degree of runout caused by a shape of the rotating body 9, using the second vibration data V2; and the balance correction information obtaining unit 14 configured to obtain the balance correction information using the first vibration data V1, the influence coefficient α, and the runout information R.

The method of obtaining balance correction information and the apparatus for obtaining balance correction information 1 obtain the runout information R using the second vibration data V2 along a direction intersecting the axis of rotation A when the rotating body 9 is rotating at the low-range rotational speed lower than the specific rotational speed without the trial weight being applied and without trial cutting being performed. As a result, the balance correction information m can be obtained with one less unknown variable than in the related art. That is, the balance correction information m can be obtained with a smaller number of measurement data. Therefore, highly accurate balance correction information m that takes runout into account can be readily obtained with a smaller number of measurement data.

In the step S11 of obtaining the first vibration data V1, the first vibration data V1 is obtained by applying a predetermined driving force to the rotating body 9 to bring the rotating body 9 into a forced rotation state of rotating at the specific rotational speed. The step S13 of obtaining the second vibration data V2 is performed after the step S11 of obtaining the first vibration data V1, and application of the predetermined driving force that was applied in the step S11 of obtaining the first vibration data V1 is stopped (S12), and the second vibration data V2 is obtained with the rotating body 9 in a free rotation state in which the rotational speed of the rotating body 9 gradually decreases. According to this step S13, accurate runout information can be obtained.

The method of obtaining balance correction information further comprises: the step S16 of obtaining the fourth vibration data V4 along a direction intersecting the axis of rotation A, when the rotating body 9 on which trial cutting has been performed at a second correction position different from the first correction position is rotating at the specific rotational speed; and the step S17b of obtaining the second influence coefficient α indicating a degree of an effect that the performance of the trial cutting has on vibration of the rotating body 9, using the third vibration data V3 and the fourth vibration data V4. According to these steps S16 and S17b, so-called two-plane balancing can be performed as the correction of the rotational balance.

The method of obtaining balance correction information and the apparatus for obtaining balance correction information are not limited to the above examples and may be implemented in various forms.

In the step S15 and the step S16, it is sufficient to cause a change in mass that brings about a change in the rotational balance of the rotating body 9. In the step S15 and the step S16, the change in the rotational balance was caused by cutting the rotating body 9. For example, the change in the rotational balance of the rotating body 9 may be caused by attaching a trial weight.

In the step S15 of a first example, a first trial weight is attached to a first axial position. In the step S16 of the first example, a second trial weight different from the first trial weight is attached to a second axial position. In the step S16 of the first example, the weight attached in the step S15 is not removed. According to the first example, in the step S17a, the first influence coefficient α can be obtained using the first vibration data V1 and the third vibration data V3. In the step S17b, the second influence coefficient α can be obtained using the third vibration data V3 and the fourth vibration data V4.

In the step S15 of a second example, the first trial weight is attached to the first axial position. In the step S16 of the second example, the second trial weight different from the first trial weight is attached to the second axial position. In the step S16 of the second example, the weight attached in the step S15 is removed. According to the second example, in the step S17a, the first influence coefficient α can be obtained using the first vibration data V1 and the third vibration data V3. In the step S17b, the second influence coefficient α can be obtained using the first vibration data V1 and the fourth vibration data V4.

The example balance correction may be referred to as a so-called two-plane balancing. The method of obtaining balance correction information can also be applied to a so-called single-plane balancing. In this case, the step S16 and the step S17b in the flow shown in FIG. 2 are omitted.

The works performed in the step S15 and the step S16 to bring about a change in the rotational balance of the rotating body 9 may be the same or different from each other. For example, in the step S15, trial cutting may be performed, and in the step S16, the trial weight may be attached. For example, in the step S15, the trial weight may be attached, and in the step S16, trial cutting may be performed.

For example, when the rotating body 9 is a machine integrated with a drive mechanism such as an electric motor, in the step S13, operation at a low speed and for a short time may be performed to obtain vibration data for obtaining runout information.

For example, when the rotating body 9 is a machine not integrated with a drive mechanism such as an electric motor, in the step S13, for example, an electric motor may be temporarily connected. Then, operation at a low speed and for a short time may be performed to obtain vibration data for obtaining runout information.

It is to be understood that not all aspects, advantages and features described herein may necessarily be achieved by, or included in, any one particular example. Indeed, having described and illustrated various examples herein, it should be apparent that other examples may be modified in arrangement and detail.

An example method of obtaining balance correction information of a rotating body may include: obtaining first vibration data along a direction intersecting an axis of rotation of the rotating body, when the rotating body is rotating at a specific rotational speed without a trial weight being applied to the rotating body and without trial cutting being performed on the rotating body; obtaining second vibration data along a direction intersecting the axis of rotation, when the rotating body is rotating at a low-range rotational speed lower than the specific rotational speed without the trial weight being applied to the rotating body and without the trial cutting being performed on the rotating body; obtaining third vibration data along a direction intersecting the axis of rotation, when the rotating body to which the trial weight has been applied at a first correction position is rotating at the specific rotational speed, or when the rotating body on which the trial cutting has been performed at the first correction position is rotating at the specific rotational speed; and obtaining the balance correction information based on the first vibration data, the second vibration data, and the third vibration data.

In some examples, the method may further include: obtaining an influence coefficient indicating a degree of an effect that the application of the trial weight or the performance of the trial cutting has on vibration of the rotating body, using the first vibration data and the third vibration data; and obtaining runout information indicating a degree of runout caused by a shape of the rotating body, using the second vibration data. Obtaining the balance correction information may include obtaining the balance correction information using the first vibration data, the influence coefficient, and the runout information.

In some examples, obtaining the first vibration data may include obtaining the first vibration data by applying a predetermined driving force to the rotating body to bring the rotating body into a forced rotation state of rotating at the specific rotational speed.

In some examples, obtaining the second vibration data may include obtaining the second vibration data, after obtaining the first vibration data, by stopping application of the predetermined driving force that was applied at the time of obtaining the first vibration data to bring the rotating body into a free rotation state in which the rotational speed of the rotating body gradually decreases.

In some examples, the method may further include obtaining fourth vibration data along a direction intersecting the axis of rotation, when the rotating body to which the trial weight has been applied at a second correction position different from the first correction position is rotating at the specific rotational speed, or when the rotating body on which the trial cutting has been performed at the second correction position is rotating at the specific rotational speed. Obtaining the balance correction information may include obtaining the balance correction information based on the first vibration data, the second vibration data, the third vibration data, and the fourth vibration data.

In some examples, the method may further include: obtaining another influence coefficient indicating a degree of an effect that the application of the trial weight or the performance of the trial cutting has on vibration of the rotating body, using the third vibration data and the fourth vibration data; and obtaining runout information indicating a degree of runout caused by a shape of the rotating body, using the second vibration data. Obtaining the balance correction information may include obtaining the balance correction information using the first vibration data, the other influence coefficient, and the runout information.

In some examples, the rotating body may be rotatably supported by a non-contact type bearing. The specific rotational speed may be higher than a levitation rotational speed at which the rotating body levitates from the bearing. The low-range rotational speed may be lower than the levitation rotational speed.

In some examples, the specific rotational speed may be higher than a primary critical rotational speed of the rotating body. The low-range rotational speed may be lower than the primary critical rotational speed of the rotating body.

An example apparatus for obtaining balance correction information of a rotating body may include a processor configured to: obtain first vibration data along a direction intersecting an axis of rotation of the rotating body, when the rotating body is rotating at a specific rotational speed without a trial weight being applied to the rotating body and without trial cutting being performed on the rotating body; and obtain second vibration data along a direction intersecting the axis of rotation, when the rotating body is rotating at a low-range rotational speed lower than the specific rotational speed without the trial weight being applied to the rotating body and without the trial cutting being performed on the rotating body. The processor may be further configured to: obtain third vibration data along a direction intersecting the axis of rotation, when the rotating body to which the trial weight has been applied at a first correction position is rotating at the specific rotational speed, or when the rotating body on which the trial cutting has been performed at the first correction position is rotating at the specific rotational speed; and obtain the balance correction information based on the first vibration data, the second vibration data, and the third vibration data.

An example method of balancing a rotating body may include: obtaining first vibration data along a direction intersecting an axis of rotation of the rotating body when the rotating body is rotating at a specific rotational speed before balance adjustment is performed on the rotating body; and obtaining second vibration data along a direction intersecting the axis of rotation when the rotating body is rotating at a low-range rotational speed lower than the specific rotational speed before the balance adjustment is performed on the rotating body. The method may further include: obtaining third vibration data along a direction intersecting the axis of rotation when the rotating body is rotating at the specific rotational speed after the balance adjustment is performed on the rotating body; obtaining balance correction information based on the first vibration data, the second vibration data, and the third vibration data; and balancing the rotating body using the balance correction information.

In some examples, the third vibration data may be obtained after performing the balance adjustment on a correction position of the rotating body. Performing the balance adjustment may include applying a trial weight at the correction position or performing trial cutting at the correction position.

In some examples, the method further include: obtaining an influence coefficient indicating a degree of an effect that execution of the balance adjustment on the rotating body exerts on vibration of the rotating body, using the first vibration data and the third vibration data; and obtaining runout information indicating a degree of runout caused by a shape of the rotating body, using the second vibration data. Obtaining the balance correction information may include obtaining the balance correction information using the first vibration data, the influence coefficient, and the runout information.

In some examples, obtaining the first vibration data may include obtaining the first vibration data by applying a predetermined driving force to the rotating body to bring the rotating body into a forced rotation state of rotating at the specific rotational speed.

In some examples, obtaining the second vibration data may include obtaining the second vibration data, after obtaining the first vibration data, by stopping application of the predetermined driving force that was applied at the time of obtaining the first vibration data to bring the rotating body into a free rotation state in which the rotational speed of the rotating body gradually decreases.

In some examples, obtaining the second vibration data may include obtaining the second vibration data in a free rotation state in which the rotational speed of the rotating body gradually decreases.

In some examples, the method may further include obtaining fourth vibration data along a direction intersecting the axis of rotation when the rotating body is rotating at the specific rotational speed after another balance adjustment is performed on the rotating body. Obtaining the balance correction information may include obtaining the balance correction information based on the first vibration data, the second vibration data, the third vibration data, and the fourth vibration data.

In some examples, the third vibration data may be obtained after performing the balance adjustment on a first correction position of the rotating body. The fourth vibration data may be obtained after performing the other balance adjustment at a second correction position of the rotating body that is different than the first correction position.

In some examples, the method may further include: obtaining an influence coefficient indicating a degree of an effect that execution of the balance adjustment and the other balance adjustment on the rotating body exerts on vibration of the rotating body, using the third vibration data and the fourth vibration data; and obtaining runout information indicating a degree of runout caused by a shape of the rotating body, using the second vibration data. Obtaining the balance correction information may include obtaining the balance correction information using the first vibration data, the influence coefficient, and the runout information.

In some examples, the rotating body may be rotatably supported by a non-contact type bearing. The specific rotational speed may be higher than a levitation rotational speed at which the rotating body levitates from the bearing. The low-range rotational speed may be lower than the levitation rotational speed.

In some examples, the specific rotational speed may be higher than a primary critical rotational speed of the rotating body. The low-range rotational speed may be lower than the primary critical rotational speed of the rotating body.

What is claimed is:

1. A method of obtaining balance correction information of a rotating body, the method comprising:
obtaining first vibration data along a direction intersecting an axis of rotation of the rotating body, when the rotating body is rotating at a specific rotational speed without a trial weight being applied to the rotating body and without trial cutting being performed on the rotating body;
obtaining second vibration data along a direction intersecting the axis of rotation, when the rotating body is rotating at a low-range rotational speed lower than the specific rotational speed without the trial weight being applied to the rotating body and without the trial cutting being performed on the rotating body;
obtaining third vibration data along a direction intersecting the axis of rotation, when the rotating body to which the trial weight has been applied at a first correction position is rotating at the specific rotational speed, or when the rotating body on which the trial cutting has been performed at the first correction position is rotating at the specific rotational speed; and
obtaining the balance correction information based on the first vibration data, the second vibration data, and the third vibration data.

2. The method according to claim 1, further comprising:
obtaining an influence coefficient indicating a degree of an effect that the application of the trial weight or the performance of the trial cutting has on vibration of the rotating body, using the first vibration data and the third vibration data; and
obtaining runout information indicating a degree of runout caused by a shape of the rotating body, using the second vibration data,
wherein obtaining the balance correction information includes obtaining the balance correction information using the first vibration data, the influence coefficient, and the runout information.

3. The method according to claim 1, wherein obtaining the first vibration data includes obtaining the first vibration data by applying a predetermined driving force to the rotating body to bring the rotating body into a forced rotation state of rotating at the specific rotational speed.

4. The method according to claim 3, wherein obtaining the second vibration data includes obtaining the second vibration data, after obtaining the first vibration data, by stopping application of the predetermined driving force that was applied at the time of obtaining the first vibration data to bring the rotating body into a free rotation state in which the rotational speed of the rotating body gradually decreases.

5. The method according to claim 1, further comprising:
obtaining fourth vibration data along a direction intersecting the axis of rotation, when the rotating body to which the trial weight has been applied at a second correction position different from the first correction position is rotating at the specific rotational speed, or when the rotating body on which the trial cutting has been performed at the second correction position is rotating at the specific rotational speed,
wherein obtaining the balance correction information includes obtaining the balance correction information based on the first vibration data, the second vibration data, the third vibration data, and the fourth vibration data.

6. The method according to claim 5, further comprising:
obtaining another influence coefficient indicating a degree of an effect that the application of the trial weight or the performance of the trial cutting has on vibration of the rotating body, using the third vibration data and the fourth vibration data; and
obtaining runout information indicating a degree of runout caused by a shape of the rotating body, using the second vibration data,
wherein obtaining the balance correction information includes obtaining the balance correction information using the first vibration data, the other influence coefficient, and the runout information.

7. The method according to claim 1,
wherein the rotating body is rotatably supported by a non-contact type bearing,
wherein the specific rotational speed is higher than a levitation rotational speed at which the rotating body levitates from the bearing, and
wherein the low-range rotational speed is lower than the levitation rotational speed.

8. The method according to claim 1,
wherein the specific rotational speed is higher than a primary critical rotational speed of the rotating body, and
wherein the low-range rotational speed is lower than the primary critical rotational speed of the rotating body.

9. An apparatus for obtaining balance correction information of a rotating body, the apparatus comprising a processor configured to:
obtain first vibration data along a direction intersecting an axis of rotation of the rotating body, when the rotating body is rotating at a specific rotational speed without a trial weight being applied to the rotating body and without trial cutting being performed on the rotating body;
obtain second vibration data along a direction intersecting the axis of rotation, when the rotating body is rotating at a low-range rotational speed lower than the specific rotational speed without the trial weight being applied to the rotating body and without the trial cutting being performed on the rotating body;
obtain third vibration data along a direction intersecting the axis of rotation, when the rotating body to which the trial weight has been applied at a first correction position is rotating at the specific rotational speed, or when the rotating body on which the trial cutting has been performed at the first correction position is rotating at the specific rotational speed; and
obtain the balance correction information based on the first vibration data, the second vibration data, and the third vibration data.

10. A method of balancing a rotating body, the method comprising:
obtaining first vibration data along a direction intersecting an axis of rotation of the rotating body when the rotating body is rotating at a specific rotational speed before balance adjustment is performed on the rotating body;
obtaining second vibration data along a direction intersecting the axis of rotation when the rotating body is rotating at a low-range rotational speed lower than the specific rotational speed before the balance adjustment is performed on the rotating body;
obtaining third vibration data along a direction intersecting the axis of rotation when the rotating body is rotating at the specific rotational speed after the balance adjustment is performed on the rotating body;
obtaining balance correction information based on the first vibration data, the second vibration data, and the third vibration data; and
balancing the rotating body using the balance correction information.

11. The method according to claim 10,
wherein the third vibration data is obtained after performing the balance adjustment on a correction position of the rotating body, and
wherein performing the balance adjustment includes applying a trial weight at the correction position or performing trial cutting at the correction position.

12. The method according to claim 10, further comprising:
obtaining an influence coefficient indicating a degree of an effect that execution of the balance adjustment on the rotating body exerts on vibration of the rotating body, using the first vibration data and the third vibration data; and
obtaining runout information indicating a degree of runout caused by a shape of the rotating body, using the second vibration data,
wherein obtaining the balance correction information includes obtaining the balance correction information using the first vibration data, the influence coefficient, and the runout information.

13. The method according to claim 10, wherein obtaining the first vibration data includes obtaining the first vibration data by applying a predetermined driving force to the rotating body to bring the rotating body into a forced rotation state of rotating at the specific rotational speed.

14. The method according to claim 13, wherein obtaining the second vibration data includes obtaining the second vibration data, after obtaining the first vibration data, by stopping application of the predetermined driving force that was applied at the time of obtaining the first vibration data to bring the rotating body into a free rotation state in which the rotational speed of the rotating body gradually decreases.

15. The method according to claim 10, wherein obtaining the second vibration data includes obtaining the second vibration data in a free rotation state in which the rotational speed of the rotating body gradually decreases.

16. The method according to claim 10, further comprising obtaining fourth vibration data along a direction intersecting the axis of rotation when the rotating body is rotating at the specific rotational speed after another balance adjustment is performed on the rotating body,
wherein obtaining the balance correction information includes obtaining the balance correction information based on the first vibration data, the second vibration data, the third vibration data, and the fourth vibration data.

17. The method according to claim 16,
wherein the third vibration data is obtained after performing the balance adjustment on a first correction position of the rotating body, and
wherein the fourth vibration data is obtained after performing the other balance adjustment at a second correction position of the rotating body that is different than the first correction position.

18. The method according to claim 16, further comprising:
obtaining an influence coefficient indicating a degree of an effect that execution of the balance adjustment and the other balance adjustment on the rotating body exerts on vibration of the rotating body, using the third vibration data and the fourth vibration data; and
obtaining runout information indicating a degree of runout caused by a shape of the rotating body, using the second vibration data,
wherein obtaining the balance correction information includes obtaining the balance correction information using the first vibration data, the influence coefficient, and the runout information.

19. The method according to claim 10,
wherein the rotating body is rotatably supported by a non-contact type bearing,
wherein the specific rotational speed is higher than a levitation rotational speed at which the rotating body levitates from the bearing, and
wherein the low-range rotational speed is lower than the levitation rotational speed.

20. The method according to claim 10,
wherein the specific rotational speed is higher than a primary critical rotational speed of the rotating body, and
wherein the low-range rotational speed is lower than the primary critical rotational speed of the rotating body.
